(19) United States
(12) Patent Application Publication
(10) Pub. No.: US 2010/0114599 A1
(43) Pub. Date: May 6, 2010

(54) SYSTEM FOR EVALUATION PATIENT CARE OUTCOMES

(76) Inventors: Justin Lanning, Franklin, TN (US); Christopher Kuzniak, Nashville, TN (US); Marty Fitzgerald, Franklin, TN (US)

Correspondence Address: W. EDWARD RAMAGE, COMMERCE CENTER SUITE 1000, 211 COMMERCE ST, NASHVILLE, TN, 37201, US

(21) Appl. No.: 12/610,286

(22) Filed: Oct. 31, 2009

Related U.S. Application Data
(60) Provisional application No. 61/110,228, filed on Oct. 31, 2008.

(51) Int. Cl. G06Q 50/00; G06Q 10/00

(52) U.S. Cl. 705/2

(57) ABSTRACT

A system for providing healthcare providers, hospitals, and health plans with quality and cost data for risk-adjusted outcomes for patients within clinical service lines. The system integrates with the provider's or hospital's existing data management systems and sources to analyze patient care and outcomes using statistical analysis. The system produces tailored, risk-adjusted clinical outcomes and cost models, highlighting opportunities for improvements within a provider's or hospital's clinical landscapes, allowing providers, hospitals and health plans to quantify cost savings through focused efforts to improve clinical quality and reduce adverse effects. The system concentrates on class of complication, cost of complications, and financial returns and providing hospitals and health plans a comprehensive view of clinical performance.

This application claims priority to U.S. Provisional Application No. 61/110,228, entitled “System for Evaluating Patient Care Outcomes,” filed on Oct. 31, 2008, and is entitled, in whole or in part, to that filing date. The complete disclosure, specification, drawings and attachments of U.S. Provisional Application No. 61/110,228 are incorporated herein by specific reference for all purposes.

### FIELD OF INVENTION

This invention relates to a system and method analyzing surgical and general patient care and outcomes using statistical analysis.

### BACKGROUND OF THE INVENTION

As healthcare costs continue to escalate, issues concerning quality and quality variances are becoming increasingly important and transparent. Hospitals, healthcare providers and health plans are now finding themselves facing an increasingly competitive economic situation forcing them to address every issue pertaining to the bottom line. Currently lacking is the ability to consistently and effectively track, benchmark, and report surgical quality outcomes and quality related cost of such outcomes.

### SUMMARY OF THE INVENTION

In one exemplary embodiment, the present invention comprises a system providing healthcare providers, hospitals, and health plans with quality and cost data for risk-adjusted outcomes for patients within clinical service lines. The system uses innovative data capture methods and integrates with the provider's or hospital's existing data management systems and sources to analyze patient care and outcomes using statistical analysis. The system produces tailored, risk-adjusted clinical outcomes and cost models, highlighting opportunities for improvements within a provider's or hospital's clinical landscapes, allowing providers, hospitals and health plans to quantify cost savings through focused efforts to improve clinical quality and reduce adverse effects. In an exemplary embodiment, the system concentrates on class of complication, cost of complications, and financial returns and providing hospitals and health plans a comprehensive view of clinical performance.

### BRIEF DESCRIPTION OF THE DRAWINGS

FIG. 1 shows a view of a system for inpatient surgery in accordance with an embodiment of the present invention.

FIG. 2 shows a view of a system for outpatient surgery in accordance with an embodiment of the present invention.

FIG. 3 shows an outcomes application data map for determining the presence or absence of a urinary tract infection.

FIG. 4 shows an example of a user login screen.

FIG. 5 shows an example of a unit selection screen.

FIG. 6 shows an example of a clipboard view patient information summary.

FIG. 7 shows an alternative configuration of a patient “index card” from a clipboard view patient information summary.

FIG. 8 shows an example of a hover panel or box in a clipboard view patient information summary.

FIG. 9 shows an example of a patient detail screen.

FIG. 10 shows an example of a hover panel or box in a patient detail screen.

FIG. 11 shows an example of an alert detail box in a patient detail screen.

FIG. 12 shows an example of a comprehensive metabolic panel with highlighted cautionary values.

FIG. 13 shows an example of a question details box in a patient detail screen.

FIG. 14 shows an example of a patient details box in a patient detail screen.

FIG. 15 shows an example of several forms of observed complications reports.

FIG. 16 shows an example of a quarterly trend report.

FIG. 17 shows an example of an LOS table.

### DETAILED DESCRIPTION OF EXEMPLARY EMBODIMENTS

In one exemplary embodiment, the present system provides healthcare providers, hospitals, and health plans with quality and cost data for risk-adjusted outcomes for patients within clinical service lines. The system uses innovative data capture methods and integrates with the provider's or hospital's existing data management systems and sources to analyze patient care and outcomes using statistical analysis. The system produces tailored, risk-adjusted clinical outcomes and cost models, highlighting opportunities for improvements within a provider's or hospital's clinical landscapes, allowing providers, hospitals and health plans to quantify cost savings through focused efforts to improve clinical quality and reduce adverse effects. In an exemplary embodiment, the system concentrates on class of complication, cost of complications, and financial returns and providing hospitals and health plans a comprehensive view of clinical performance.

In one exemplary embodiment, the present invention comprises a computer-based system adapted to consistently and objectively capture data regarding pre-existing medical conditions, intra-operative data, and the presence of major adverse outcomes to create an observed outcome to expected outcome comparison. The number of major adverse outcomes can vary. Statistical modeling is based on the peer-reviewed, academically published, and universally accepted National Surgical Quality Improvement Program (NSQIP) risk-adjustment statistical modeling. This method was pioneered within the Veterans Administration Healthcare system, leading to a 27% reduction in complications, a 47% reduction in mortality and a 50% reduction in length of stay (LOS). The data capture solutions and reporting architecture enables users to have a standard view of clinical quality outcomes and related costs by procedure and complication utilizing nationally proven measures. It allows users to view data by physician, hospital, hospital system, and region.

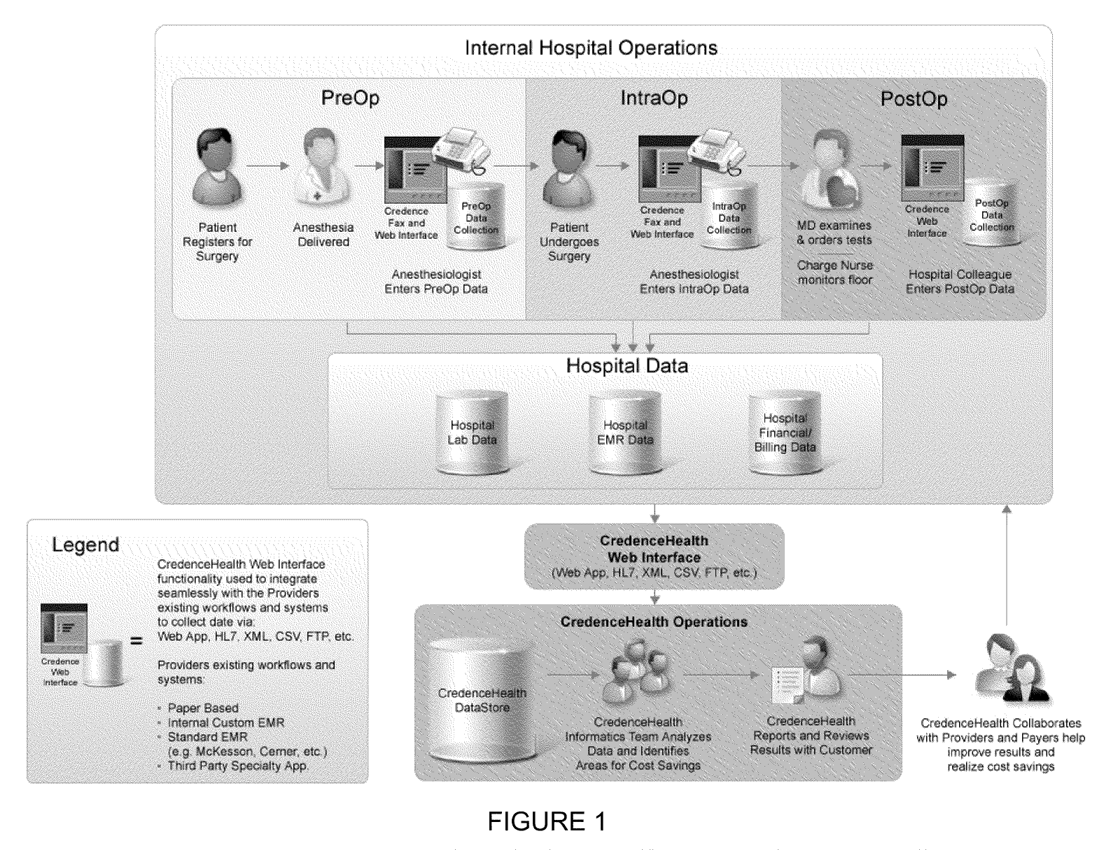

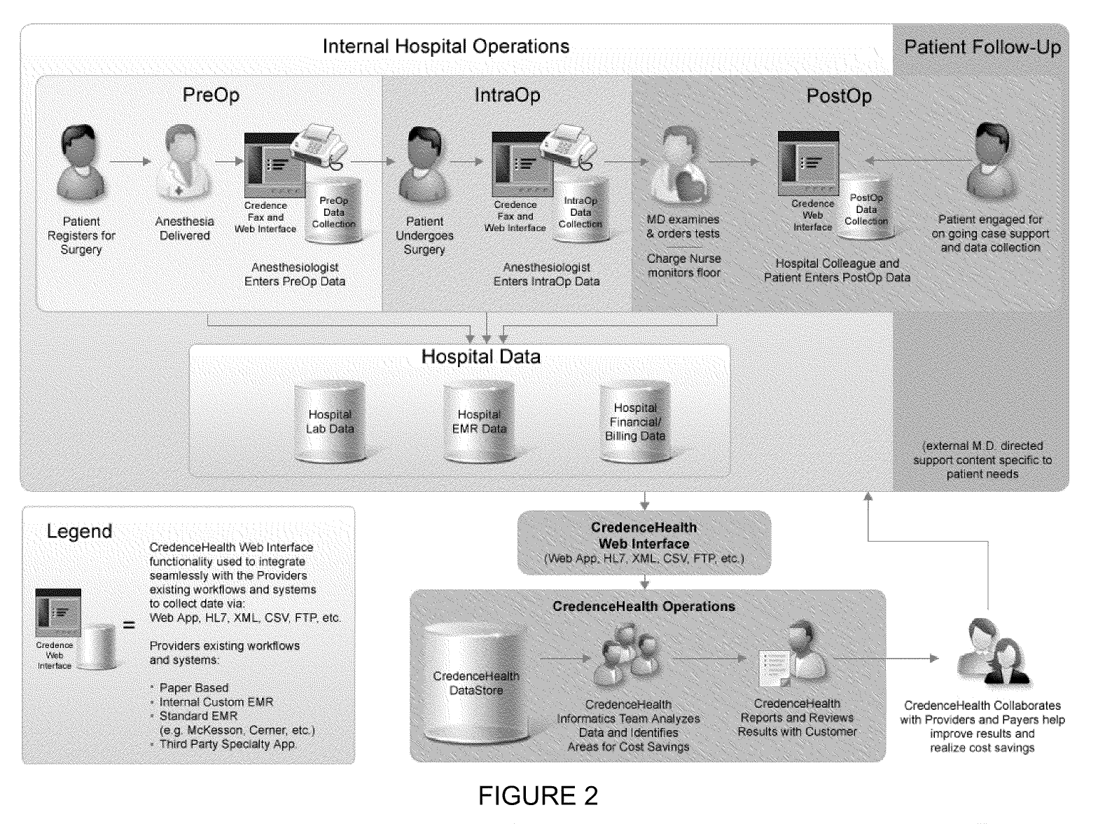

As seen in FIGS. 1 and 2, the system works seamlessly with multiple different Electronic Medical Records (EMR), administrative data systems, and financial accounting systems to extract essential data for analysis. FIG. 1 shows how elements of the system interface with existing internal hospital systems for inpatient surgery, while FIG. 2 shows the same for outpatient surgery. Through a developed data integration process and data receiving software, the system is able to quickly and efficiently capture vital demographic, administrative, and financial data from multiple different systems.

In another exemplary embodiment, the system comprises a “data audit” procedure where pre-defined data needs are assessed to determine the availability and location within a user's information technology (IT) landscape. Once all data needs are defined and data sources are located within the IT landscape, pre-existing or custom data extraction processes are used to map IT data directly into the system. Once captured, this data is then entered into the analytic portion of the system for statistical modeling.

Data captured includes pre-existing medical conditions. Pre-existing medical conditions drive outcomes. The system comprises a consistent and objective method for data capture describing pre-existing medical conditions.

In one embodiment focused on surgical patients, the most reliable and consistent data source for pre-existing clinical data is the anesthesia clinical providers. Any patient who undergoes a procedure must be evaluated by an anesthesiologist. In various embodiments, anesthesia providers are provided several options for pre-operative data collection:

Option 1: Completion of Pre-Operative/Intra-Operative Evaluation Form.

This form enables anesthesia providers to capture all major data related to performance of their clinical duties. In addition, this standard form provides reminders to anesthesia providers to collect vital data points proven to be significant in risk adjusted outcomes modeling. Once this form is completed, it is faxed to a recipient portal where the data is either scanned into a pre-existing automated data collection device or manually entered into the system. Once captured, this data is then entered into the analytic portion of the system for statistical modeling.

Option 2: Direct Data Entry into System Software Application.

This option utilizes specially designed software for entry of Pre-operative and Intra-operative data. The anesthesia provider directly interfaces with the application to record all relevant data to performance of their clinical duties. In addition, the software provides prompts to the user to enter vital data points proven to be significant in risk adjusted outcomes modeling. Once captured, this data is then entered into the analytic portion of the system for statistical modeling.

Data captured includes post-operative data. Post-operative data capture can be the most comprehensive and significant portion of the invention. In this embodiment, the system provides consistent and unbiased post-operative adverse event diagnosis. One of the most reliable and consistent data source for post-operative adverse event diagnosis data is the ward charge nurse role. Complications tracked include, but are not limited to, acute renal failure, bleeding requiring transfusion, cardiac arrest with ACLS, myocardial infarction, deep vein thrombosis, pulmonary embolism, respiratory failure requiring intubation, prolonged ventilator dependence, pneumonia, cerebrovascular stroke, coma, neuropathy, surgical site infection, wound dehiscence, urinary tract infection, sepsis, systemic inflammatory response syndrome, organ space infections, catheter related infection, pressure ulcer, post-operative ileus, and death.

In another exemplary embodiment, the system comprises a software application designed around the workflow of the charge nurse to integrate tasks and aggregate data to increase efficiency in performance of clinical duties. This solution integrates a variety of clinical data repositories, including but not limited to laboratory data, radiological data, clinical parameter data, medical diagnostic testing data, and direct charge nurse entered data, to provide essential data points to run algorithmic analysis of patient outcomes to determine the presence or absence of adverse medical events. Data input mechanisms are objective and thus remove any provider bias from diagnosis of adverse events. Further, in an alternative embodiment, the software design is such that all available data is analyzed prior to any direct provider input in order to minimize the time and effort required for data entry by the charge nurse.

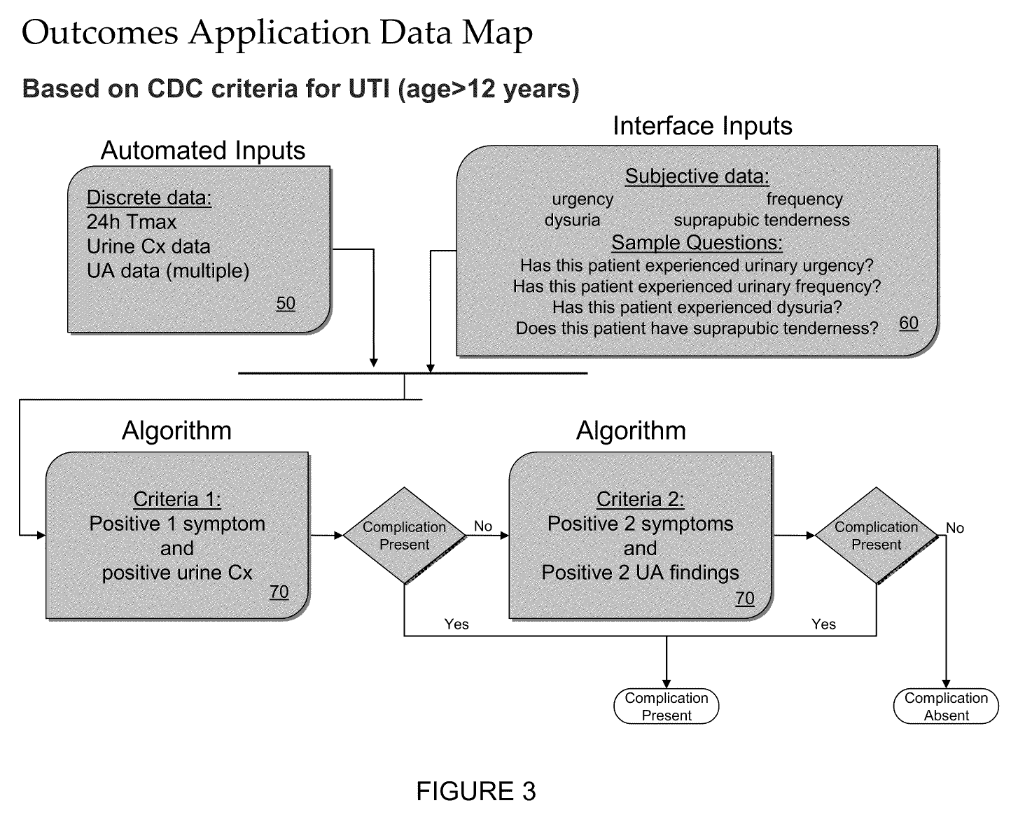

Once the appropriate clinical data is aggregated and analyzed or “screened,” if there is a high likelihood of an adverse event diagnosis present, prompts are provided in the form of objective questions for the charge nurse (or other person) to answer about the current clinical state of a patient. Once the question(s) is answered, the system applies a clinical algorithm to determine the likelihood of presence or absence of an adverse outcome. FIG. 3 shows an outcomes application data map, based on CDC criteria, for determining the presence or absence of a urinary tract infection (UTI) for a patient over 12 months old. The system collects automated inputs 50, combines this with subjective data and answers to questions 60, and subjects this data according to one or more algorithms 70 to determine if a complication is present. Similar data maps with corresponding inputs and algorithms are used for other complications. This data is then entered into the analytic portion of the solution for statistical modeling.

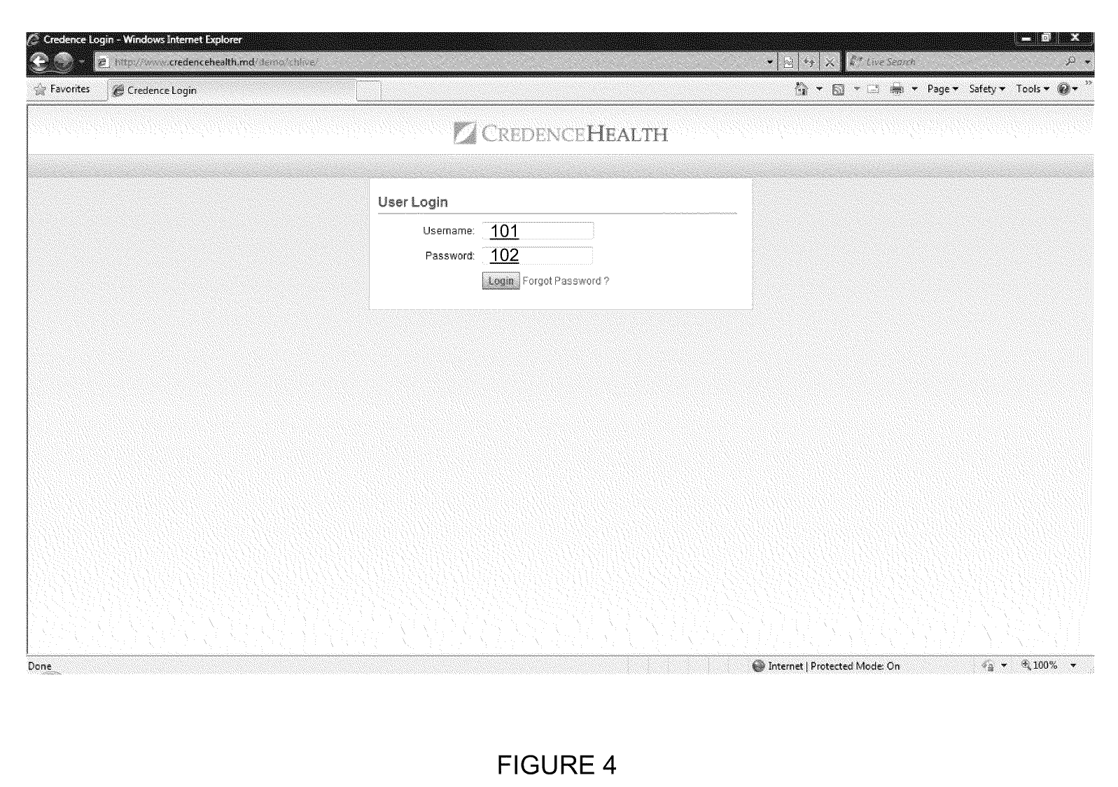

One exemplary embodiment comprises a web-based, active server page (ASP) that provides real-time clinical information. A user may access the system through any standard web browser operated on a computing device connected to the Internet or other network. When a user first accesses the application, they are prompted to login, as seen in FIG. 4. At the login screen, the user enters his or her personal username 101 and password 102 (which may be HIPAA compliant) to access their account, and any role-based data assigned to their account.

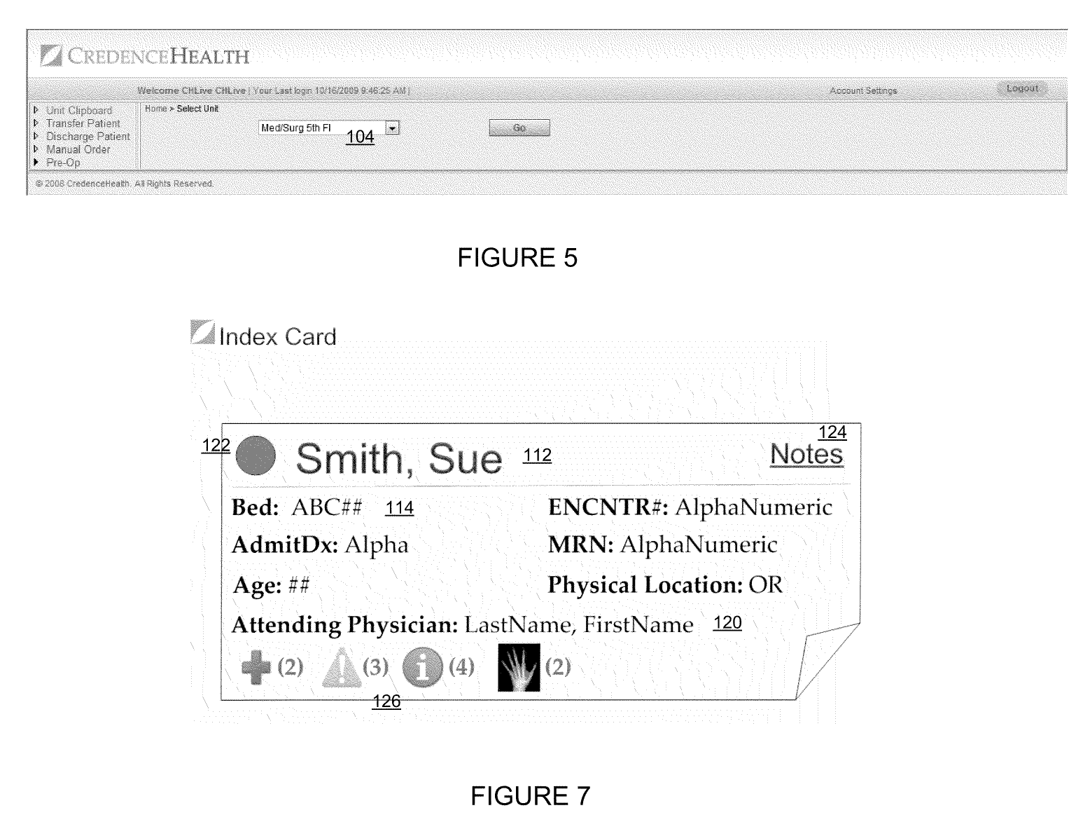

Upon successfully logging in, the user is taken to a Unit Selection Screen (or window), where he or she may choose a unit or assortment of patients to view. The user may be assigned to or able to view multiple units, and may be presented with a drop-down menu 104, as seen in FIG. 5, allowing them to choose which of those units to view. For example, a medical professional assigned to a surgical unit in a hospital may be presented the option to view the 5^{th} floor surgical unit. Selecting the unit (by clicking on the unit, by double-clicking on the unit, or by selecting the unit in a menu and hitting a “go” button), takes the user to a screen with information on the unit.

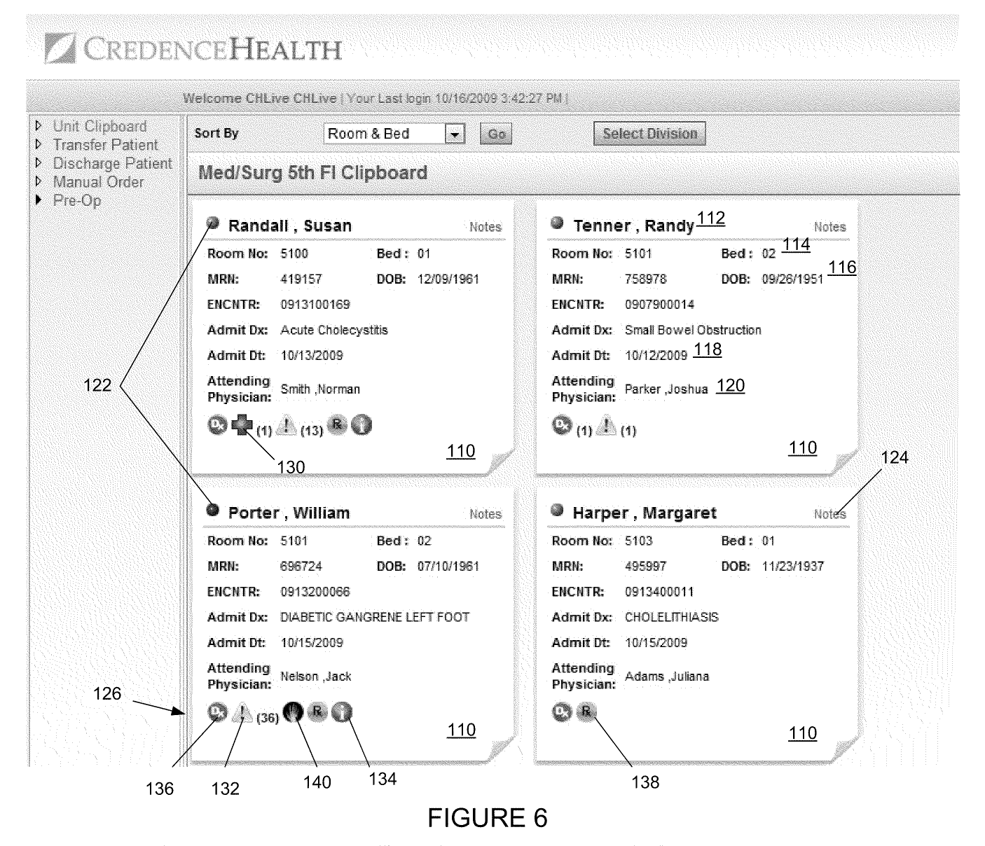

In one embodiment, as partially seen in FIG. 6, this screen is presented as a “clipboard” of all patients in that unit, or patients that are assigned to that user. Patient data is displayed in summary fashion, updated in real time, and may be organized as a series of boxes, windows or “index cards” 110. FIG. 6 shows four index cares, although a smaller or larger number of index cards may be included on the screen, and the user may scroll down using a scroll bar or other tool to view all of the index cards. Each index card comprises basic patient information, including but not limited to name 112, bed number 114, date of birth 116, admission date 118, and attending physician 120. A link to written notes 124 about the patient is provided. An alert indicator 122 in the upper left hand corner of each index card provides an indication to the user as to whether an action needs to be taken with regard to that particular patient. The alert indicator 122 may be a symbol, polygon, icon, word, or the like (e.g., an exclamation point), and may be colored or flashing. Alternatively, the alert indicator may be a circle, as seen in FIGS. 6 and 7, with differences in the circle indicating whether or not an action needs to be taken. For example, a green circle would indicate no action needs to be taken, while a red circle would indicate an action is required. Similarly, an unfilled circle may indicate no action needs to be taken, while a filled circle would indicate an action is required.

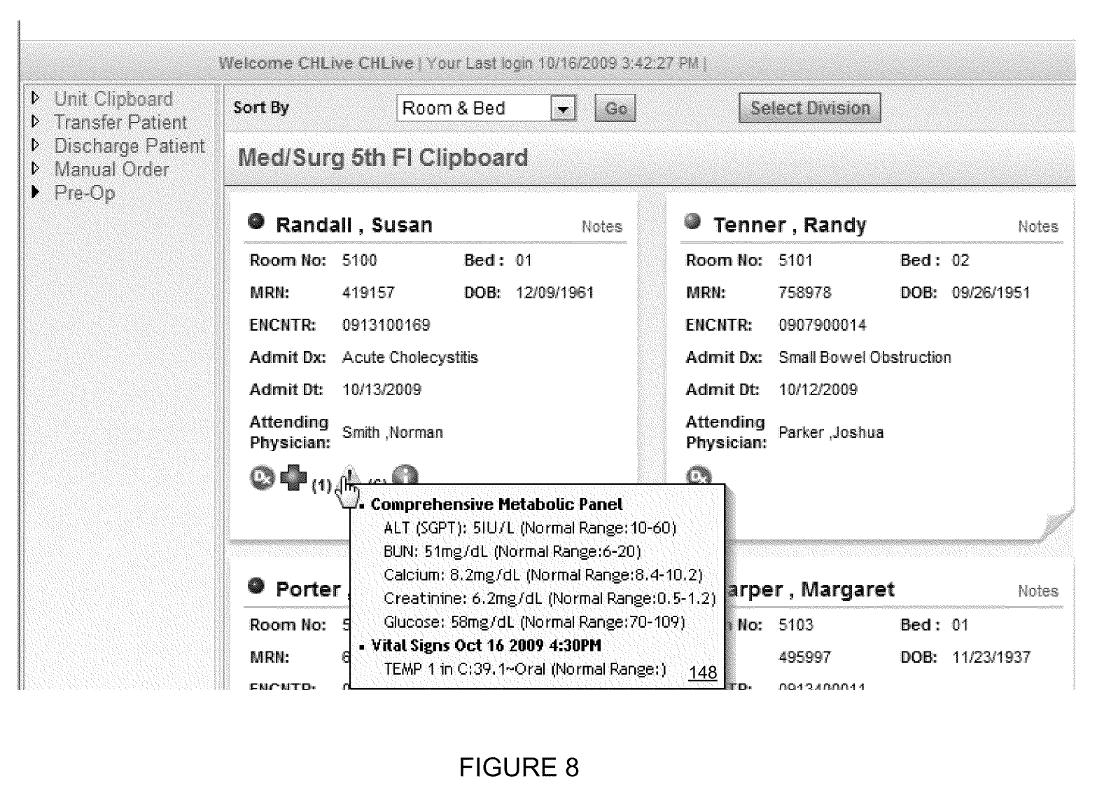

Each index card also has a row or rows of icons 126 across the bottom of the card, although they may be placed elsewhere on the card in other configurations. These icons represent specific data within the patient record. Icons include, but are not limited to, the following:
[symbol] Critical Alert Icon 130: this icon is present when data have been received that indicate a critically out of range lab or vital signs value. When present, this icon will also display a numeric value that indicates the number of abnormal data elements (e.g., 2 abnormal lab values are present).
[symbol] Caution Icon 132: this icon is present when data have been received that indicate abnormal lab or vital signs values, but that are not yet critically out of range. When present, this icon will also display a numeric value that indicates the number of abnormal data elements (e.g., 2 abnormal lab values are present).
[symbol] Information Icon 134: this icon indicates that all current lab and vital signs values are normal and displays them for informational purposes only.
[symbol] Diagnosis Icon 136: this icon refers to the identified diagnoses (admitting diagnoses, working diagnoses, and system identified diagnoses). When present, this icon will also display a numeric value that indicates the number of current diagnoses.
[symbol] Pharmacy Icon 138: this icon indicates all currently ordered drugs for a patient.
[symbol] Radiology Icon 140: this icon indicates the presence of radiology report for a patient. When present, this icon will also display a numeric value that indicates the number of radiology reports for that patient.
   When the user hovers over an icon with the mouse pointer, the information linked to that icon appears in a small box or window to provide immediate information to the user without the need to click or go to a separate web page. For example, as shown in FIG. 8, hovering over the Caution icon displays vital signs and comprehensive metabolic data 148. Similarly, hovering over the Rx icon displays all current medications for the patient.

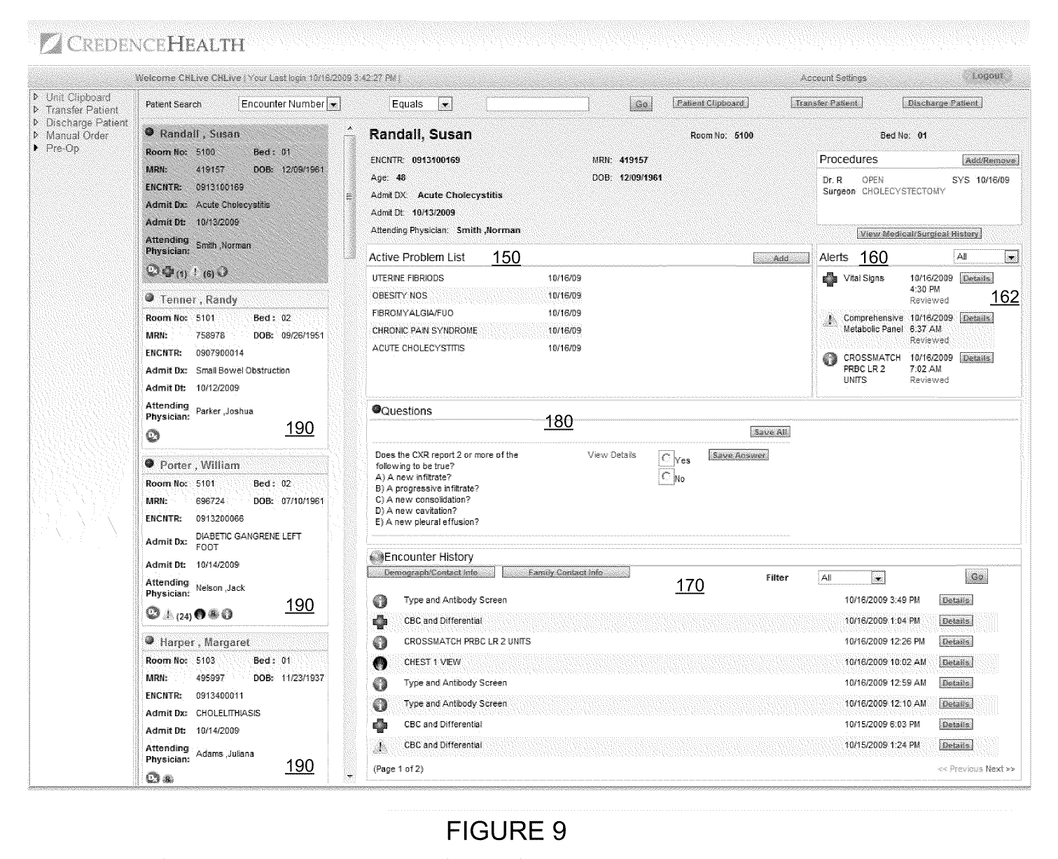

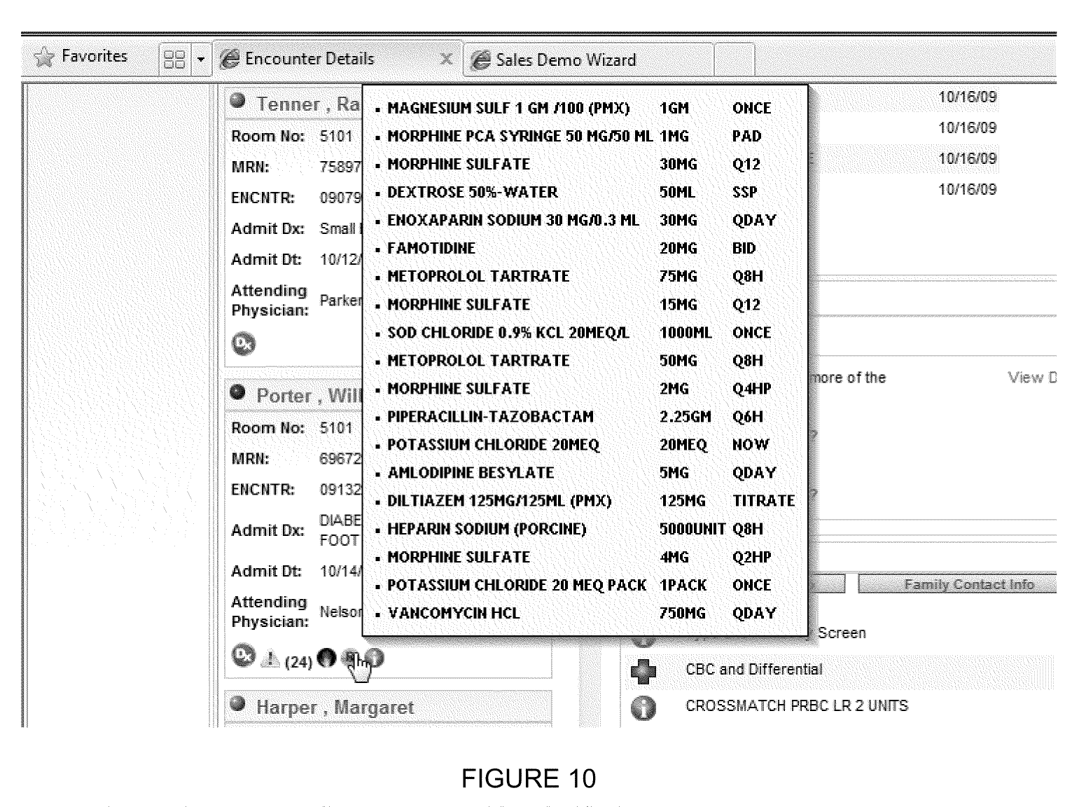

The user may click on the patient's index card to enter the Patient Detail Screen. As seen in FIG. 9, detailed information about the patient is shown in a series of boxes, panes or windows, 150, 160, 170, 180, containing more detailed patient information. This screen also may continue to display other patients' index cards 190, maintaining hover functionality and continuing to be updated in real time, as seen in FIG. 10.

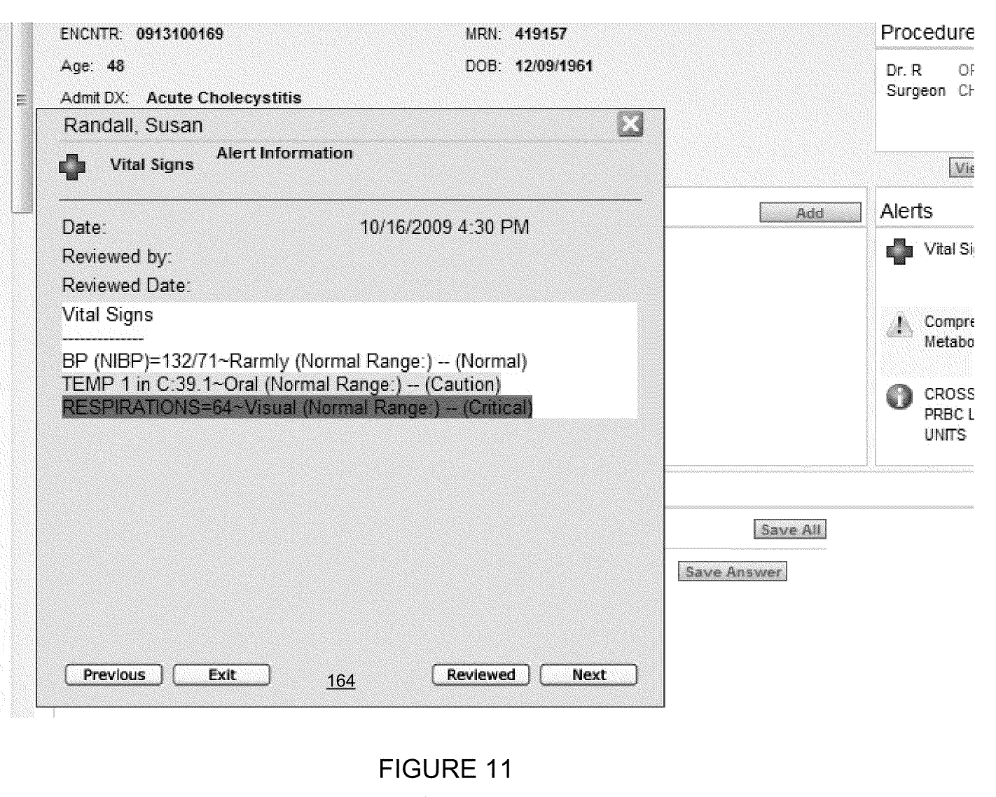

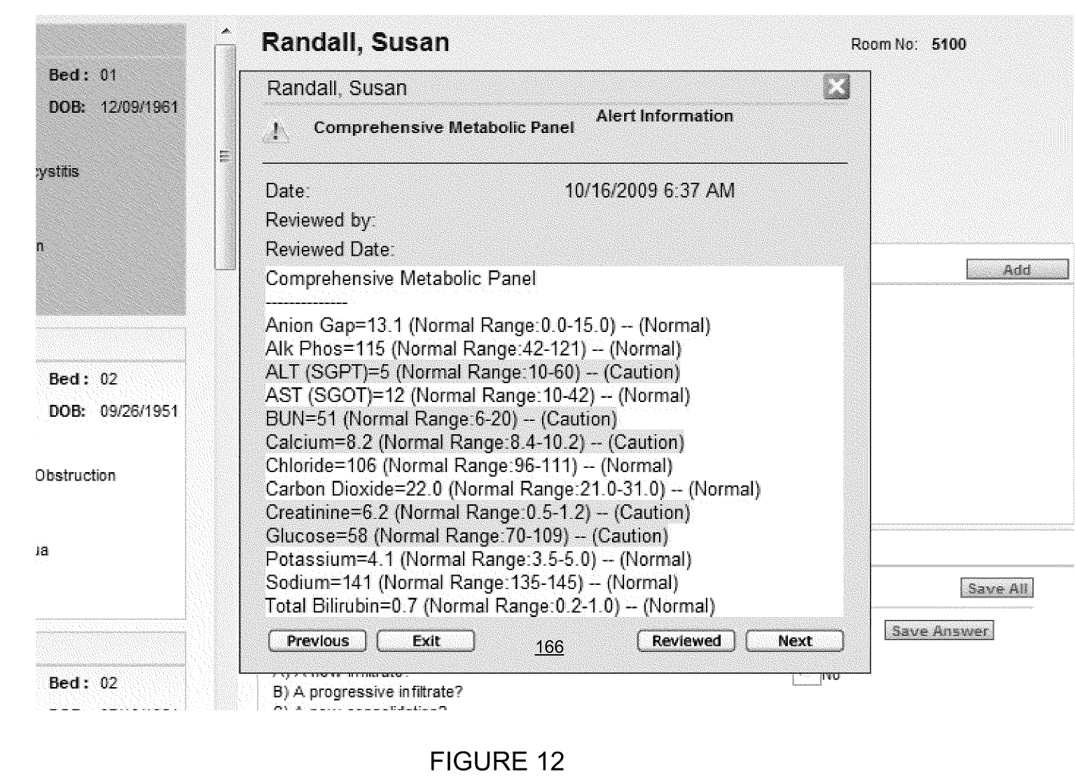

In the Patient Detail Screen, the user may view all Active Problems 150, any Alerts 160, the Encounter History 170, and any Questions 180 that the system has identified and flagged for the user to answer. From the Alert box 160, the user may elect to view details (such as by selecting a “details” button 162) about a critical alert or cautions alert in a separate panel or window 164, as seen in FIG. 11. Cautionary values may be highlighted in yellow (or other suitable color), while critical values may be highlighted in red (or other suitable color). A panel or window 166 for an exemplary comprehensive metabolic alert with highlighted cautionary values is shown in FIG. 12.

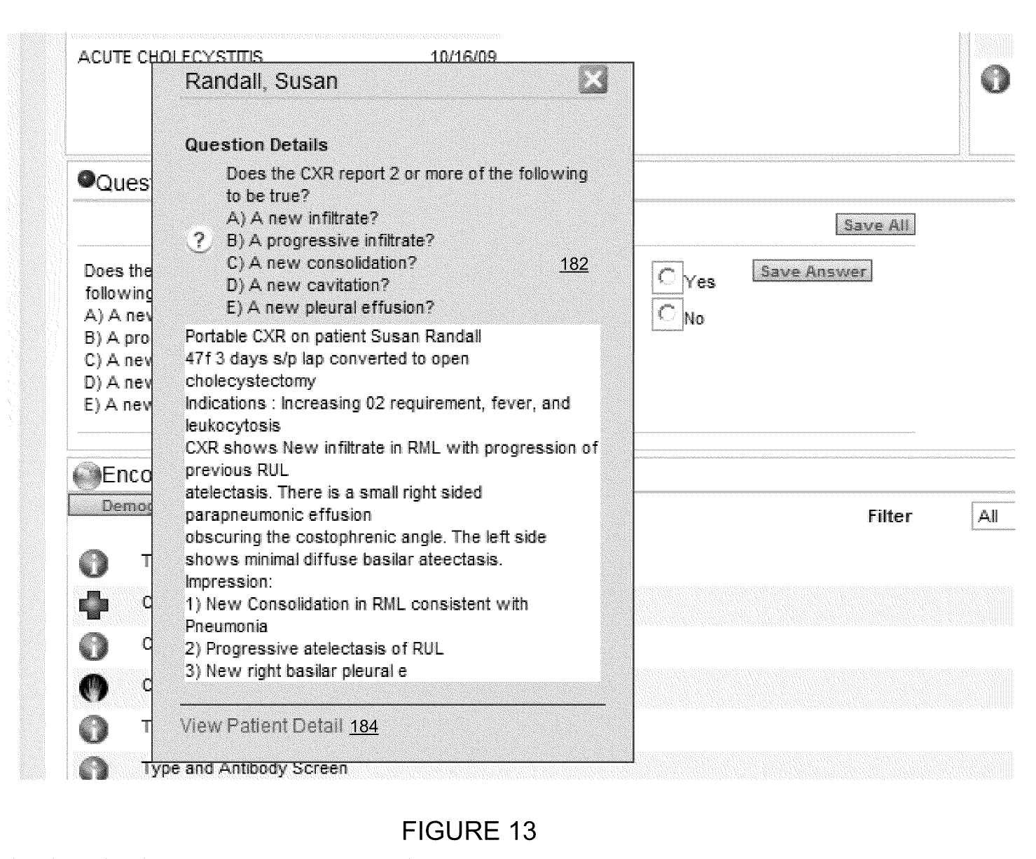

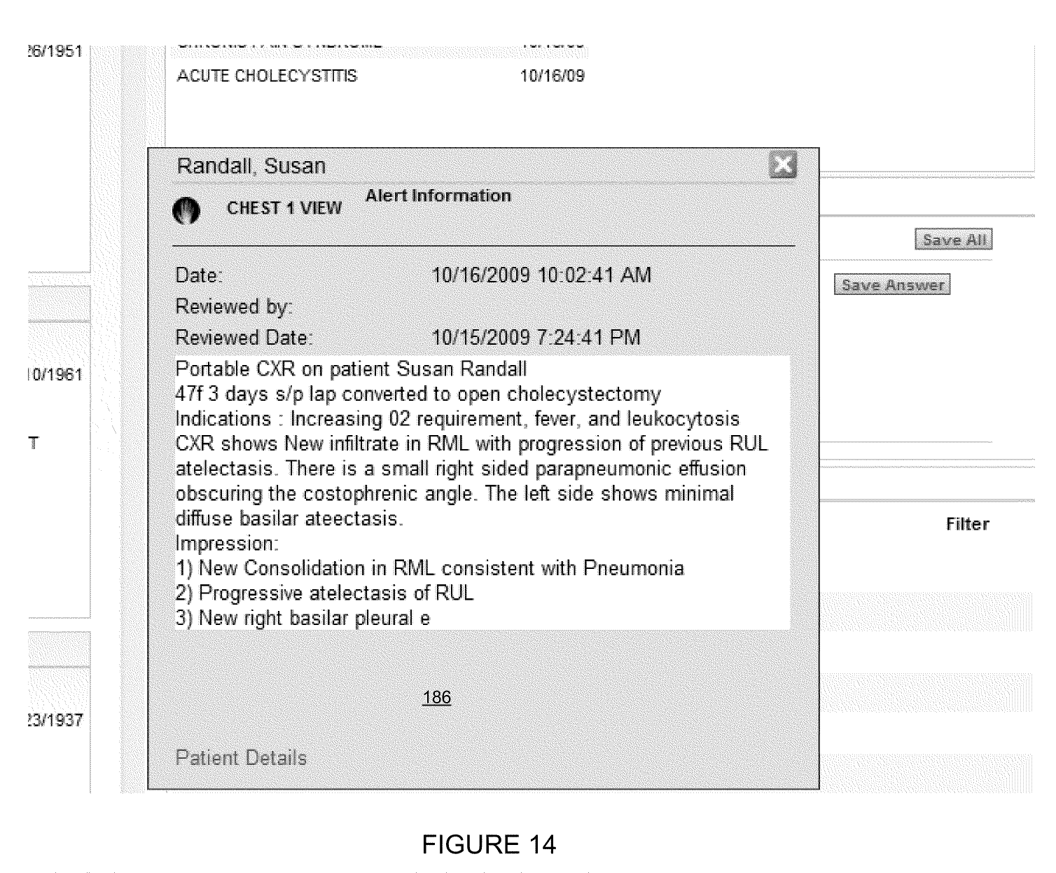

The Questions box 180 identifies questions that the system has identified for the user. The existence of one or more questions will turn the alert indicator on the corresponding index card to alert status, alerting the user to enter the Patient Detail Screen to view the question. As seen in FIG. 13, the user then sees the question and answers it (in the example shown, the user is queried about a chest x-ray that was ordered and entered electronically into the hospital system). The user may choose to view more detail about the question in a separate window 182. The user may select the View Patient Detail option 184, which displays the written radiology report 186, as seen in FIG. 14.

Once data is entered into the system, it can then be mapped to an appropriate location for analysis. In one embodiment, analytics are run in an automated and rolling fashion to provide real-time result for risk-adjusted quality and cost outcomes. Data analytics may be built directly into the software using existing and standard statistical modeling. The risk-adjusted outcomes modeling may be based on the VA NSQIP, as referenced earlier. Linear regression may be used to create cost/adverse-event data.

In one embodiment, the analytical analysis comprises the development of an expected-to-observed ratio for each type of complication in a hospital or facility. A computer processor, or similar device, calculates the risk-adjusted rate of expected complications in the hospital or facility, and uses NSQIP publicly-available data to develop logistic regression models, which can be developed for each type of complication (e.g., infectious, cardiovascular, respiratory, thromboembolic, and the like). A logistic regression model predicts the rate of complication based on the patient's characteristics. The system then runs the regression model or models on the user data set, which has captured the same patient characteristics as the regression model. The appropriate regression model should be chosen for each type of clinical complication the user is interested in. The model generates a risk-adjusted, user-specific expected rate for that complication.

The system then calculates the user's observed rate of complications, which can be calculated directly as a percentage (e.g., total number of each type of complication divided by the appropriate number of patients). The system then compares the user's observed rate of a complication to the risk-adjusted expected rate of that complication. If Observed/Expected (O/E) is greater than 1, this indicates that the user has substantial potential to improve conditions or treatments to lower its complication rate. If O/E is less than 1, this indicates the user has outperformed its peer group.

In another embodiment, the analytical analysis comprises the development a risk-adjusted cost per type of complication, specific for each user. The system can use the user's own accounting or financial software or system to assign a cost to each patient's hospital stay. The system uses a linear regression model (or models) to predict the risk-adjusted cost for a complication, with a focus on the hospital cost per patient. Independent variables include, but are not limited to, procedure complexity, patient characteristics, and other complications. The system uses the results of the linear regression model to generate a risk-adjusted prediction of cost per type of complication, specific to the user. The linear regression determines which patient variables are statistically significant in predicting the outcome of interest (e.g., cost of the hospital stay), and generates coefficients for each of the patient variables that are statistically significant predictors. These coefficients are exponentiated to determine the percent increase in cost (or outcome of interest) associated with the presence of each specific variable. The greater the number of statistically significant variables used to calculate cost per complication, the more accurate the cost per complication will be.

In another embodiment, the analytical analysis uses the risk-adjusted cost per complication generated by the linear regression model to predict potential cost savings for the users. The system may multiply the risk-adjusted cost per complication by the observed complication rate to determine how much money the user spends in treating complications (i.e., increased hospital cost). The system also may calculate the differential user cost by multiplying the risk-adjusted cost per complication by the difference between the observed complication rate and the expected complication rate to determine how much more money the user spends in treating complications than its peers or competitors.

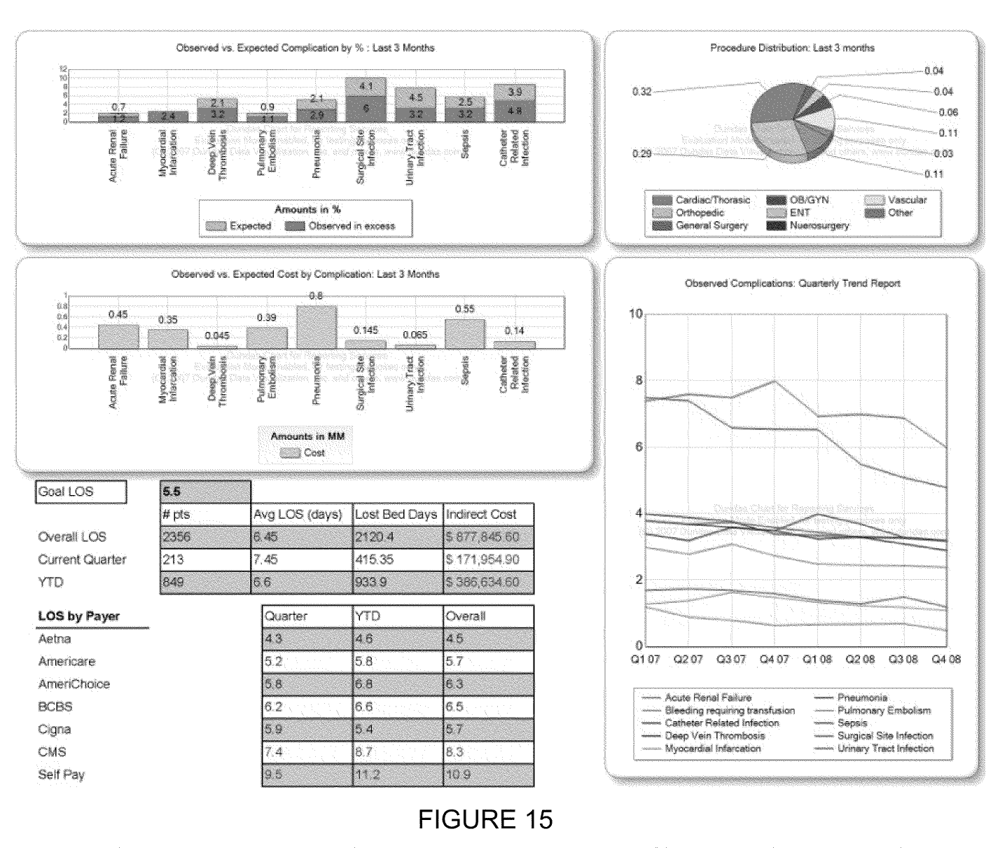

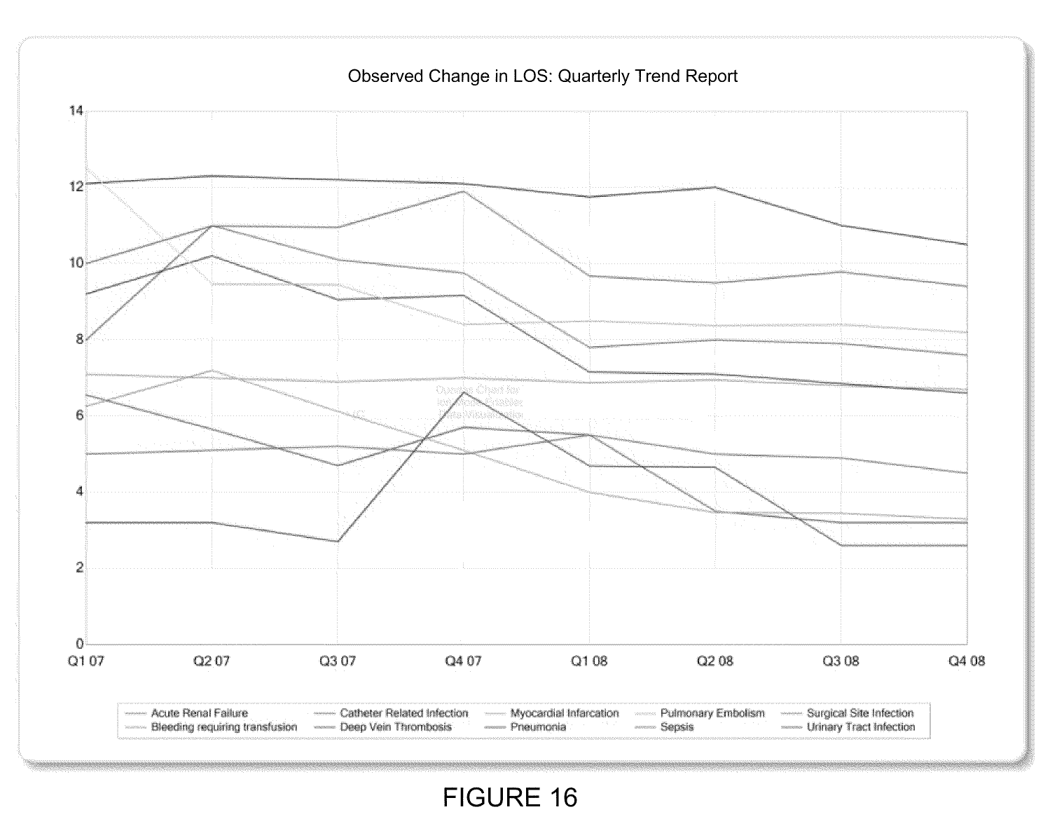

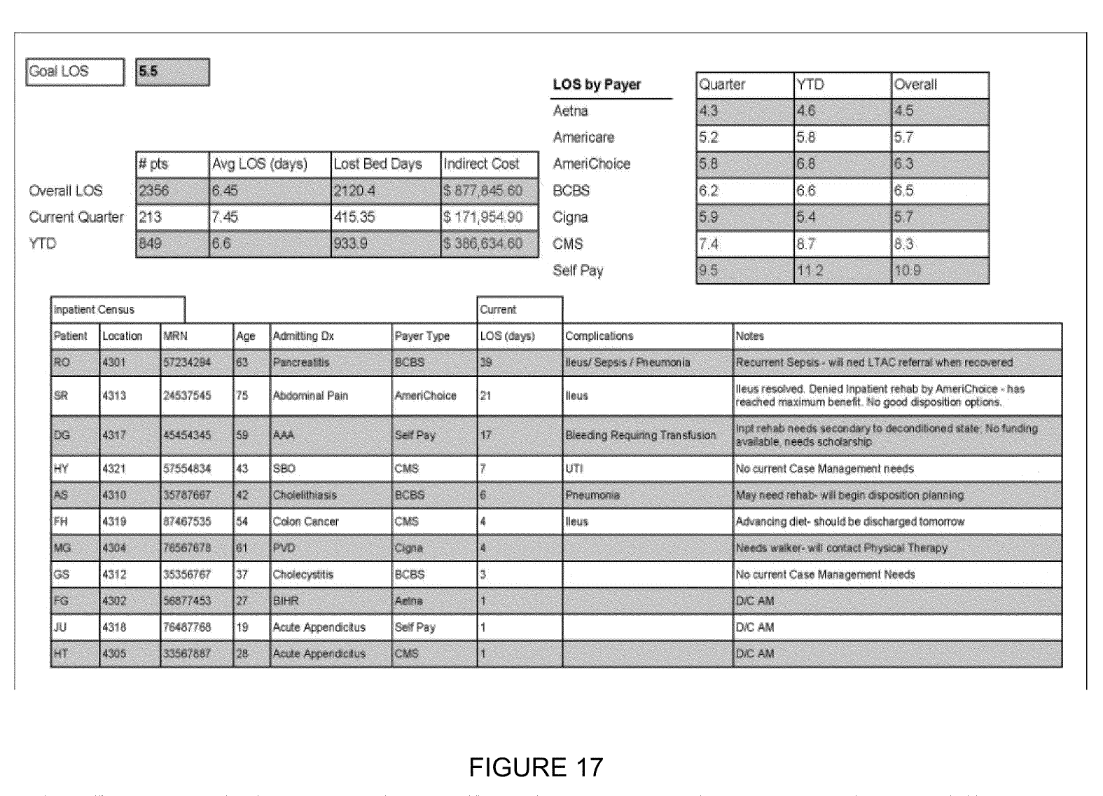

During or after completion of some or all of the analytics, real-time reports are available to users. The reports include providing the necessary information to make informed and value decisions for new or ongoing quality improvement and cost reduction efforts. Reports may be customized. Examples of reports, which may combine numeric and graphical data, are shown in FIGS. 15-17.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, routines, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media and may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

It should be understood that the embodiments and examples described herein have been chosen and described in order to best illustrate the principles, methods, and processes of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

We claim:

1. A system for collecting and analyzing patient data, comprising:
one or more computer servers, said servers in electronic communication with an internal computer network or system at a hospital or healthcare facility;
one or more data processing computer programs operating in computer memory, said data processing computer programs adapted to capture demographic, administrative and financial data from the internal computer network or system; and
one or more databases connected to the computer servers for storing the captured data;
wherein the captured data is analyzed by a computer processor to determine the presence or absence of one or more complications for patients.

2. The system of claim 1, wherein the complications comprise one or more of acute renal failure, bleeding requiring transfusion, cardiac arrest with ACLS, myocardial infarction, deep vein thrombosis, pulmonary embolism, respiratory failure requiring intubation, prolonged ventilator dependence, pneumonia, cerebrovascular stroke, coma, neuropathy, surgical site infection, wound dehiscence, urinary tract infection, sepsis, systemic inflammatory response syndrome, organ space infections, catheter related infection, pressure ulcer, post-operative ileus, or death.

3. The system of claim 1, further comprising a user interface adapted to provide real-time clinical information.

4. The system of claim 3, wherein the user interface comprises a web-based, active server page.

5. The system of claim 3, further comprising a screen presenting a plurality of patient data presenting in summary fashion in one or more boxes or screens.

6. The system of claim 5, further comprising an alert indicator or icon for each set of patient data.

7. The system of claim 3, further comprising a patient detail screen presenting one or more questions about the patient.

8. The system of claim 1, further wherein a computer processor determines an expected-to-observed ratio for the rate of each type of complication.

9. The system of claim 8, wherein the rate of expected complications is calculated by developing a logistic regression model using publicly-available data.

10. The system of claim 9, wherein the rate of observed complication is calculated by applying the logistic regression model to the data for the hospital or healthcare facility.

11. The system of claim 8, further wherein a computer processor determines a risk-adjusted cost per type of complication for the hospital or healthcare facility.

12. The system of claim 11, further wherein a computer processor generates a prediction of potential cost savings for the hospital or healthcare facility.

13. The system of claim 12, further wherein the computer processor provides one or more reports presenting the results of the analysis.
